(19) United States
(12) Patent Application Publication
(10) Pub. No.: US 2018/0039523 A1
(43) Pub. Date: Feb. 8, 2018

(54) INFORMATION PROCESSING SYSTEM THAT DETERMINES A MEMORY TO STORE PROGRAM DATA FOR A TASK CARRIED OUT BY A PROCESSING CORE

(71) Applicant: TOSHIBA MEMORY CORPORATION, Tokyo (JP)

(72) Inventors: Takayuki AKAMINE, Yokohama Kanagawa (JP); Kenichiro YOSHII, Bunkyo Tokyo (JP); Hiroshi YAO, Yokohama Kanagawa (JP)

(21) Appl. No.: 15/438,683

(22) Filed: Feb. 21, 2017

(30) Foreign Application Priority Data
Aug. 3, 2016 (JP) 2016-153159

(51) Int. Cl. G06F 9/50

(52) U.S. Cl. CPC G06F 9/5044; G06F 2209/501

(57) ABSTRACT

An information processing system includes a first core, a second core having a processing speed that is slower than the first core, a first memory, a second memory having a slower response time than the first memory, and a management processor. The management processor is configured to determine a core for executing a task, cause program data for executing the task to be copied to the first memory and then cause the first core to execute the task using the program data in the first memory, when the first core is determined as the core for executing the task, and cause the program data for executing the task to be copied to the second memory and then cause the second core to execute the task using the program data in the second memory, when the second core is determined as the core for executing the task.

### CROSS-REFERENCE TO RELATED APPLICATION

This application is based upon and claims the benefit of priority from Japanese Patent Application No. 2016-153159, filed on Aug. 3, 2016, the entire contents of which are incorporated herein by reference.

### FIELD

Embodiments described herein relate generally to an information processing system.

### BACKGROUND

A heterogeneous multi-core system of one type that has multiple cores different in operation speed uses a core suitable for execution of each task, and thereby, achieves highly efficient processing.

### DESCRIPTION OF THE DRAWINGS

FIG. 1 is a block diagram of an information processing system according to a first embodiment.

FIG. 2 is a flowchart of task execution processing carried out by the information processing system according to the first embodiment.

FIG. 3 is a block diagram of an information processing system according to a comparative example.

FIG. 4 is a block diagram of an information processing system according to a second embodiment.

FIG. 5 is a flowchart of task execution processing carried out by the information processing system according to the second embodiment.

FIG. 6 is a flowchart illustrating an operation carried out by a memory access controller of the information processing system according to the second embodiment.

FIGS. 7 and 8 are a conceptual diagram illustrating an operation carried out by an information processing system according to a third embodiment.

FIG. 9 is a flowchart of task execution processing carried out by the information processing system according to the third embodiment.

FIGS. 10 and 11 are a flowchart of processing when an operation core that executes a task, of the information processing system according to the third embodiment is switched from a fast core to a slow core.

### DETAILED DESCRIPTION

An embodiment is directed to increase of use efficiency of a core in an information processing system.

In general, according to an embodiment, an information processing system includes a first core, a second core having a processing speed that is slower than the first core, a first memory, a second memory having a slower response time than the first memory, and a management processor. The management processor is configured to determine a core that runs a task, cause program data for executing the task to be copied to the first memory and then cause the first core to execute the task using the program data in the first memory, when the first core is determined as the core for executing the task, and cause the program data for executing the task to be copied to the second memory and then cause the second core to execute the task using the program data in the second memory, when the second core is determined as the core for executing the task.

Hereinafter, embodiments will be described with reference to the drawings.

### First Embodiment

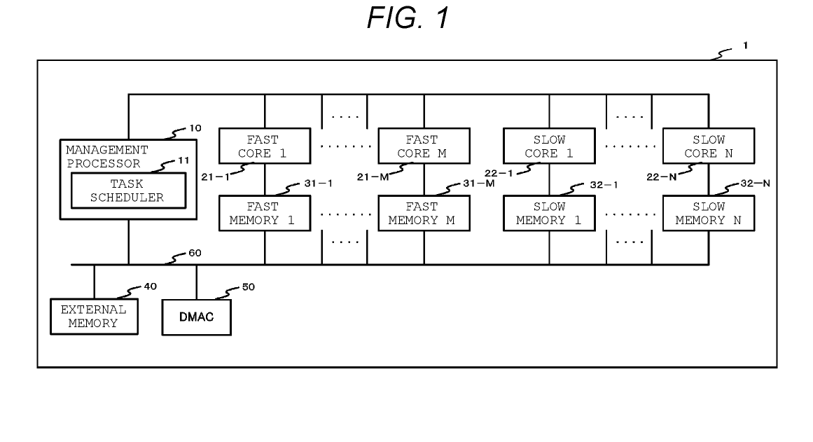

FIG. 1 is a block diagram of an information processing system according to a first embodiment. The information processing system 1 according to the first embodiment includes a management processor 10, a plurality of fast cores 21-1, . . . , and 21-M, a plurality of fast memories 31-1, . . . , and 31-M, a plurality of slow cores 22-1, . . . , and 22-N, a plurality of slow memories 32-1, . . . , and 32-N, an external memory 40, and a DMAC 50. M and N are arbitrary natural numbers, respectively.

The information processing system 1 may be an information processing device such as a personal computer or a server device, a mobile phone, an imaging device, may be a mobile terminal such as a tablet computer or a smart phone, may be a game machine, or may be a vehicle mounting terminal such as a car navigation system.

The plurality of fast cores 21-1, . . . , and 21-M, the plurality of fast memories 31-1, . . . , and 31-M, the plurality of slow cores 22-1, . . . , and 22-N, the plurality of slow memories 32-1, . . . , and 32-N, the management processor 10, the external memory 40, and the DMAC 50 may be mounted on a common substrate (not illustrated). The substrate may be a substrate with a single layer or may be a substrate with stacked layers.

In the following description, if one of the plurality of fast cores 21-1, . . . , and 21-M needs to be specified, reference numerals 21-1, . . . , and 21-M are used. However, if an arbitrary fast core is indicated or if a certain fast core is not distinguished from other fast cores, the reference numeral 21 is used.

In the following description, if one of the plurality of slow cores 22-1, . . . , and 22-N needs to be specified, reference numerals 22-1, . . . , 22-N are used. However, if an arbitrary slow core is indicated or if a certain slow core is not distinguished from other slow cores, the reference numeral 22 is used.

In the following description, if one of the plurality of fast memories 31-1, . . . , and 31-M needs to be specified, the reference numeral 31-M is used. However, if an arbitrary fast memory is indicated or if a certain fast memory is not distinguished from other fast memories, the reference numeral 31 is used.

In the following description, if one of the plurality of slow memories 32-1, . . . , and 32-N needs to be specified, the reference numerals 32-1, . . . , and 32-N are used. However, if an arbitrary slow memory is indicated or if a certain slow memory is not distinguished from other slow memories, the reference numeral 32 is used.

The fast core 21 and the slow core 22 respectively control an operation of the information processing system 1. The fast core 21 and the slow core 22 are each cores. A core is a processor such as a central processing unit (CPU). In addition, the core is also referred to as a processor core. The fast core 21 can also be referred to as a first core. In addition, the slow core 22 can also be referred to as a second core.

Each of the fast memory 31 and the slow memory 32 stores a program or data. The fast memory 31 can also be referred to as a first memory. In addition, the slow memory 32 can also be referred to as a second memory.

The fast memory 31 can be accessed by the fast core 21, and the fast core 21 uses the fast memory 31 as a main memory. The slow memory 32 can be accessed by the slow core 22, and the slow core 22 uses the slow memory 32 as a main memory. The main memory indicates a memory that the core directly accesses.

The fast core 21 and the slow core 22 have at least one difference in performance such as data processing performance and a power consumption amount. For example, the fast core 21 is a core with high data processing performance and a large amount of power consumption, and the slow core 22 has lower power consumption and lower data processing performance than the fast core 21.

The performance includes, for example, an operation frequency, throughput (MIPS value), a bus frequency, and a degree of parallel processing.

The information processing system 1 according to the present embodiment includes two types of cores of the fast core 21 and the slow core 22, but is not limited to the two types, and may include three or more types of cores. Furthermore, the information processing system 1 according to the present embodiment may include multiple cores for each type of core.

The fast memory 31 and the slow memory 32 have different response times or different bandwidths when the cores access. For example, the fast memory 31 is a volatile memory which can respond at a high speed, and is, for example, an SRAM or a DRAM. The fast memory 31 may be the SRAM, may be the DRAM, and may be a memory in which the SRAM and the DRAM are combined. In addition, the fast memory 31 may be a memory which can respond to a core such as a memory-type magnetoresistive random access memory (M-type MRAM) at the same speed as or a similar speed to the SRAM and the DRAM.

The slow memory 32 has longer latency than the SRAM or the DRAM, that is, needs a long response time if the core accesses. The slow memory 32 is, for example, a resistance random access memory (ReRAM), a phase change random access memory (PCM), a ferroelectric random access memory (FeRAM), a cross-point type memory, a storage-type magnetoresistive random access memory (S-type MRAM), a NAND-type flash memory, or a NOR-type flash memory, or may be a memory which can respond to the core at the same speed as those, or may be a memory in which those are combined. In addition, the slow memory 32 costs less per unit capacity than the fast memory 31 in general.

The information processing system 1 according to the present embodiment includes two types of memories including the fast memory 31 and the slow memory 32, but is not limited to the two types, and may include three or more types of memories. Furthermore, the information processing system 1 according to the present embodiment may include multiple cores for each type of memory so as to correspond to each other.

The external memory 40 is a nonvolatile storage medium which stores a program or data. The external memory 40 is, for example, a magnetic disk such as a hard disk drive, a NAND-type flash memory, an optical disk such as a DVD, or a magnetic tape.

If the slow memory 32 is a nonvolatile memory and has a large capacity, the information processing system 1 stores a program or data in the slow memory 32, and thereby, the external memory 40 may not be necessary.

When the information processing system 1 receives power, a program stored in the external memory 40 is loaded to a memory, and a core performs predetermined processing in accordance with the program which is read from the memory.

The management processor 10 is a processor such as a CPU, and manages an issued task. If a predetermined task is determined to be executed by any one core of the fast core 21 and the slow core 22, the management processor 10 requests the DMAC 50 to transfer the program or the data stored in the external memory 40 to any one memory of the fast memory 31 and the slow memory 32.

An issuance of the task is performed, for example, if the management processor 10 is notified of an issuance of a task corresponding to an application when a user starts the application of the information processing system 1, or if the management processor 10 is notified of a program which is executed by the slow core 22 when a task requiring fast calculation is executed.

The direct memory access controller (DMAC) 50 copies or moves a program or data stored in a certain storage medium onto another storage medium. For example, the DMAC 50 reads the program or the data designated by the management processor 10 from the external memory 40, and transfers the read program or the read data to the fast memory 31 or the slow memory 32. In addition, the management processor 10 may transfer a predetermined program or predetermined data stored in the external memory 40 to the fast memory 31 or the slow memory 32 without passing through the DMAC 50.

The management processor 10, the fast core 21-K (K is a natural number which satisfies 1≦K≦M), the fast memory 31-K, the external memory 40, and the DMAC 50 are connected to each other through an internal bus 60. In addition, the management processor 10, the slow core 22-L (L is a natural number which satisfies 1≦L≦N), the slow memory 32-L, the external memory 40, and the DMAC 50 are connected to each other through the internal bus 60.

The information processing system 1 may be connected through a network, instead of the internal bus 60. In addition, the information processing system 1 may further include, for example, a memory management unit, an interface for connecting an external device thereto, and the like.

In the information processing system 1, one fast core 21 corresponds to one fast memory 31, and one slow core 22 corresponds to one slow memory 32, respectively.

For example, the fast core 21-M corresponds to the fast memory 31-M, and the fast memory 31-M is used as a main memory of the fast core 21-M. The fast memory 31-M is a memory which can be directly accessed by the fast core 21-M, and cannot be accessed by the fast core 21 or the slow core 22 other than the fast core 21-M.

In the same manner, the slow core 22-N corresponds to the slow memory 32-N, and the slow memory 32-N is used as a main memory of the slow core 22-N. The slow memory 32-N is a memory which can be directly accessed by the slow core 22-N, and cannot be accessed by the slow core 22 or the fast core 21 other than the slow core 22-N.

The information processing system 1 according to the present embodiment is described as including the fast core 21, the slow core 22, the fast memory 31, and the slow memory 32 as an example, but is not limited to a combination thereof, and may include combinations of three or more types of the core and the memory, respectively.

The management processor 10 includes a task scheduler 11. The task scheduler 11 determines which core of the fast core 21 and the slow core 22 executes the issued task, based on characteristics of the issued task.

The task scheduler 11 has determination criteria for determining the core that executes the task. The task scheduler 11 has determination criteria based on an environment in which the task is executed, the amount of calculation required for the task, the memory transfer amount, and an execution status of each core, and determines a core which executes the task according to the determination criteria. For example, a criteria based on an environment in which the task is executed includes whether or not the task is executed in a background. In addition, an arbitrary core of the fast core 21 and the slow core 22 may include the function of the management processor 10 or the task scheduler 11, and in such cases, the management processor 10 can be omitted from the information processing system 1.

Each of the plurality of fast cores 21-1, . . . , and 21-M, the plurality of fast memories 31-1, . . . , and 31-M, the plurality of slow cores 22-1, . . . , and 22-N, the plurality of slow memories 32-1, . . . , and 32-N, and the management processor 10 may be configured by a large scale integration (LSI), an application specific integrated circuit (ASIC), a field-programmable gate array (FPGA), or the like.

In addition, the LSI, the ASIC, the FPGA, or the like may include all of the plurality of fast cores 21-1, . . . , and 21-M, the plurality of fast memories 31-1, . . . , and 31-M, the plurality of slow cores 22-1, . . . , and 22-N, the plurality of slow memories 32-1, . . . , and 32-N, and the management processor 10.

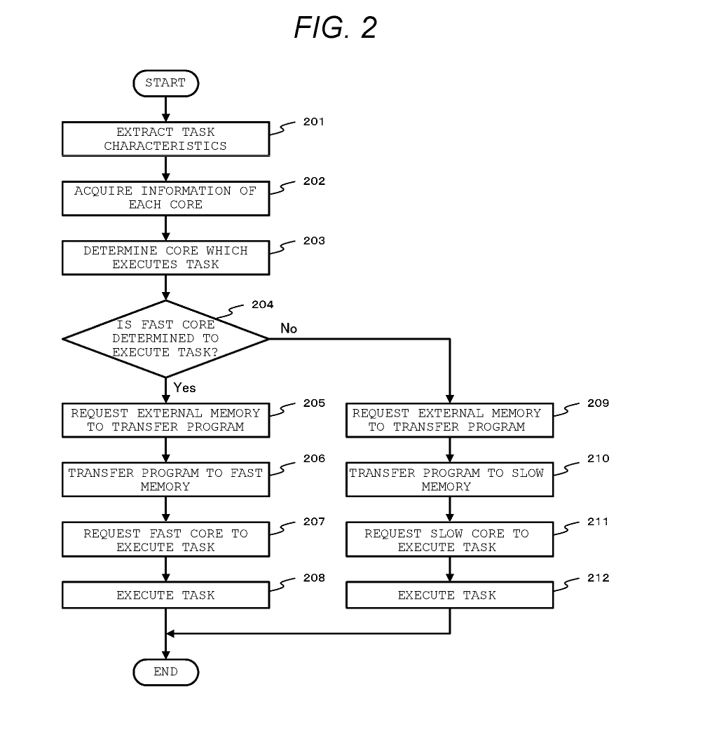

FIG. 2 is a flowchart of task execution processing carried out by the information processing system 1 according to the first embodiment. The flowchart illustrates processing from issuing of the task to executing of the task.

If the management processor 10 detects an issue of the task, the management processor 10 extracts characteristics of the issued task (step 201). For example, the management processor 10 reads metadata of the issued task from the external memory 40, and extracts the characteristics of the task from the read metadata.

The characteristics which are extracted by the management processor 10 are an environment in which the task is operated, the amount of calculation necessary for executing the task, the transfer amount of data related to the task, and the like. The environment in which the task is operated includes, for example, information on whether the task is executed in a foreground or the task is executed in a background.

The management processor 10 determines that the task is executed in the foreground, for example, if the issued task highly requires responsiveness, such as applications for game, applications for video playback, or applications for Web browser. In addition, the management processor 10 determines that the task is executed in the background, for example, if the issued task is a task which does not highly require the responsiveness, such as applications for electronic mail or applications for anti-virus of a computer.

In addition, the management processor 10 may acquire information on whether the issued task has to be executed in the foreground or has to be executed in the background, from an operating system (OS) which manages the entirety of the information processing system 1.

The characteristics of the task may be stored in the external memory 40 when the information processing system 1 is shipped, or the management processor 10 may guide the characteristics, based on a past execution situation of each of the fast cores 21-1, . . . , and 21-M and the slow cores 22-1, . . . , and 22-N.

Subsequently, the management processor 10 acquires information of each core, that is, information on resource usage of each of the fast cores 21-1, . . . , and 21-M and the slow cores 22-1, . . . , and 22-N (step 202).

The task scheduler 11 determines which core of the fast cores 21-1, . . . , and 21-M and the slow cores 22-1, . . . , and 22-N will execute the issued task, according to a predetermined determination criteria (step 203).

The predetermined determination criteria is determined based on, for example, characteristics of the task which is extracted by the management processor 10, information on the resource usage of each of the fast cores 21-1, . . . , and 21-M and the slow cores 22-1, . . . , and 22-N, or the like.

For example, the task scheduler 11 may determine which core is assigned based on the resource usage of each of the fast core 21 and the slow core 22, without considering the characteristics of the issued task. In addition, for example, the task scheduler 11 may determine which core is as signed based on characteristics of a specified task, without checking the resource usage each of the fast core 21 and the slow core 22.

For example, it is assumed that when the fast core 21 executes another task, a task that does not require responsiveness is issued. Even in this case if it is determined that executing the other task together with the issued task by the fast core 21 makes power consumption of the information processing system 1 smaller than executing the issued task by the slow core 22, the task scheduler 11 determines to execute the issued task using the fast core 21.

For example, it is assumed that although the fast core 21 executes the other task, calculation resources of the fast core 21 and the fast memory 31 are available, and the amount of calculation for the issued task and the amount of memory consumption for the issued task are relatively small. In this case, executing the other task together with the issued task by the fast core 21 may make the power consumption of the information processing system 1 smaller than executing the issued task by the slow core 22. For that reason, the task scheduler 11 determines to execute the issued task using the fast core 21.

If the task scheduler 11 determines that the issued task is executed by the fast core 21 (Yes in step 204), the management processor 10 requests the DMAC 50 to transfer a program or data stored in the external memory 40 to the fast memory 31 (step 205). The management processor 10 notifies the DMAC 50 of, for example, a head address of the DMAC 50 in which the program or the data that is a target to be transferred is stored, a size of the program or the data which is the target to be transferred, and an address indicating a storing location in the fast memory 31 which becomes a transfer destination.

The DMAC 50 reads the program or the data which is requested by the management processor 10 from the external memory 40, and transfers the read program or data to the fast memory 31 which is requested by the management processor 10 (step 206). The program or the data is stored in the fast memory 31 in a form which can be executed by the fast core 21.

The information processing system 1 may transfer the program or the data related to the task which is issued by the management processor 10 from the external memory 40 to the fast memory 31, without using the DMAC 50.

After the program or the data related to the issued task is transferred to the fast memory 31, the management processor 10 requests the fast core 21 to execute the task (step 207).

The fast core 21 that is requested to execute the task reads a predetermined program from the fast memory 31, and executes the task by interpreting description of the program (step 208).

If the task scheduler 11 determines that the issued task is executed by the slow core 22 (No in step 204), the management processor 10 requests the DMAC 50 to transfer a program or data stored in the external memory 40 to the slow memory 32 (step 209). The management processor 10 notifies the DMAC 50 of, for example, a head address of the DMAC 50 in which the program or the data that is the target to be transferred is stored, the size of the program or the data which is the target to be transferred, and the address indicating a storing location in the slow memory 32 which is a transfer destination.

The DMAC 50 reads the program or the data that is requested by the management processor 10 from the external memory 40, and transfers the read program or data to the slow memory 32 that is requested by the management processor 10 (step 210). The program or the data is stored in the slow memory 32 in a form that can be executed by the slow core 22.

The information processing system 1 may transfer the program or the data related to the task that is issued by the management processor 10 from the external memory 40 to the slow memory 32, without using the DMAC 50.

After the program or the data related to the issued task is transferred to the slow memory 32, the management processor 10 requests the slow core 22 to execute the task (step 211).

The slow core 22 that is requested to execute the task reads a predetermined program from the slow memory 32, and executes the task by interpreting description of the program (step 212).

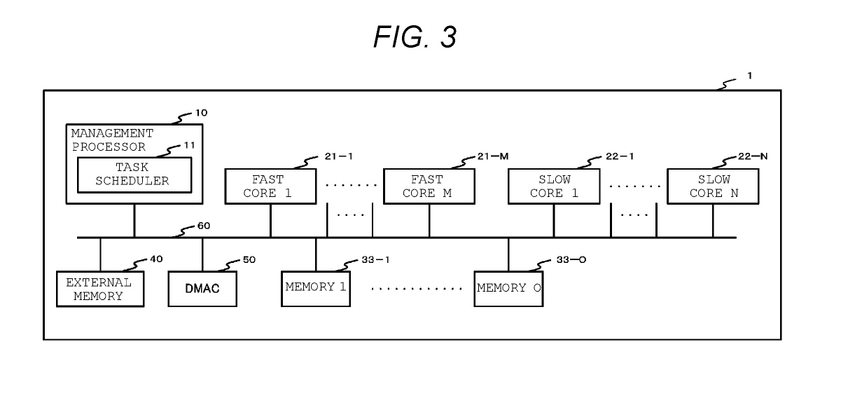

FIG. 3 is a block diagram of an information processing system according to a comparative example. The information processing system according to the comparative example includes a plurality of fast cores 21-1, . . . , and 21-M, a plurality of slow cores 22-1, . . . , and 22-N, a plurality of memories 32-1, . . . , and 32-O, a management processor 10, an external memory 40, and a DMAC 50. O is an arbitrary natural number. The plurality of fast cores 21-1, . . . , and 21-M, the plurality of slow cores 22-1, . . . , and 22-N, the plurality of memories 33-1, . . . , and 33-O, the management processor 10, the external memory 40, and the DMAC 50 are connected to each other by an internal bus 60.

As illustrated in FIG. 3, the information processing system according to the comparative example includes the plurality of memories 33-1, . . . , and 33-O instead of the plurality of fast memories 31-1, . . . , and 31-M and the plurality of slow memories 32-1, . . . , and 32-N. In addition, in the following description, if it is necessary to specify one of the plurality of memories 33-1, . . . , and 33-O, reference numerals 33-1, . . . , and 33-O are used. However, if an arbitrary memory of the plurality of memories 33-1, . . . , and 33-O is indicated or if a certain memory of the plurality of memories 33-1, and 33-O is not distinguished from other memories, a reference numeral 33 is used.

The memory 33 can be accessed by the fast core 21 and the slow core 22, and is used as a main memory of the fast core 21 or the slow core 22.

If the memory 33 is a volatile memory which can respond at the same high speed as the fast memory 31, data are stored in a volatile memory which can respond at a high speed, although the data are used in a task which does not require a high calculation capacity. The data causes shortage of capacity of the memory 33, and disturbs fast execution of the task which requires a high calculation capacity. In addition, a volatile memory which can respond at a high speed is expensive in general, and does not disturb the fast execution of the task which requires a high calculation capacity. Accordingly, in order to increase capacity of the memory 33, cost of the information processing system according to the comparative example would increase.

In addition, if the memory 33 has the same response performance as the slow memory 32, response time when the memory 33 respond after the fast core 21 accesses the memory increases, compared to a case where a DRAM or the like is used instead of the memory 33. In this case, use efficiency of the fast core 21 would decrease, and use performance of the information processing system according to the comparative example would be degraded even if the fast core 21 is used.

In contrast, the information processing system according to the present embodiment uses the fast memory 31 conforming to performance of the fast core 21 as a main memory of the fast core 21, and uses the slow memory 32 conforming to performance of the slow core 22 as a main memory of the slow core 22. Accordingly, it is possible to prevent the use efficiency of the information processing system according to the present embodiment to reduce cost, and to increase capacity of a main memory.

As described above, according to the first embodiment, the information processing system 1 includes the management processor 10, the fast core 21, the slow core 22, the fast memory 31 corresponding to the fast core 21, and the slow memory 32 corresponding to the slow core 22. The management processor 10 determines which of the fast core 21 and the slow core 22 executes the issued task. If the management processor 10 determines that the task is executed by the fast core 21, a program or data corresponding to the task is stored in the fast memory 31, and the fast core 21 executes the program by using the fast memory 31. If the management processor 10 determines that the task is executed by the slow core 22, a program or data corresponding to the task is stored in the slow memory 32, and the slow core 22 executes the program by using the slow memory 32. A core which executes a task is used properly according to the task, and a main memory which is used by the core is used properly according to performance of a core which performs the processing. Accordingly, use efficiency of the core can increase, capacity of the main memory can increase, and power consumption of the information processing system 1 can be reduced.

### Second Embodiment

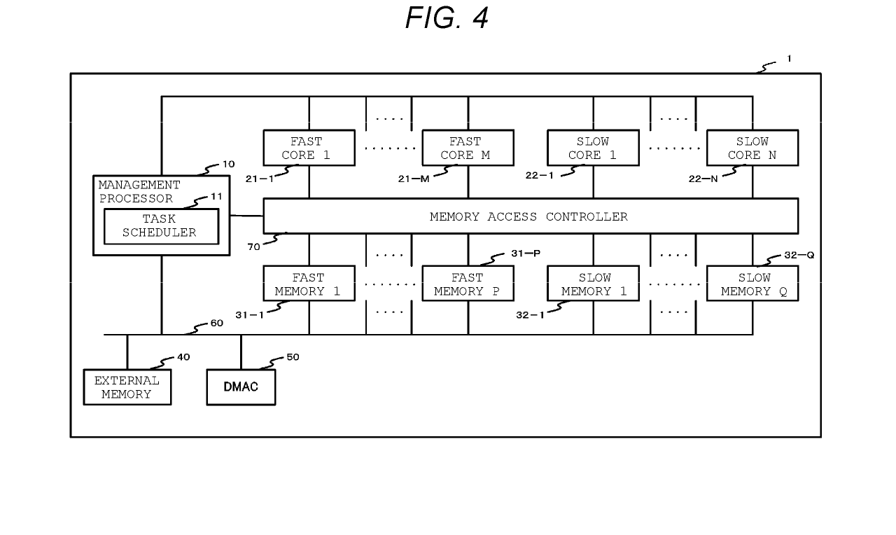

FIG. 4 is a block diagram of an information processing system according to a second embodiment. In the second embodiment, the same symbols or reference numerals will be attached to elements having the same function as or a similar function to the first embodiment, and description thereof will be omitted. In addition, other configurations that are not described in the following configuration are the same as those in the first embodiment.

The information processing system 1 according to the second embodiment includes a memory access controller 70.

In the information processing system 1 according to the second embodiment, the fast core 21 and the fast memory 31, and the slow core 22 and the slow memory 32 may not respectively have one-to-One correspondence. The number of the fast memories 31 which are included in the information processing system 1 is P, and the number of the slow memories 32 which are included in the information processing system 1 is Q. P and Q are arbitrary natural numbers. P may be the same as M and may be different from M. In addition, Q may be the same as N and may be different from N.

In the present embodiment, reference numerals 31-1, . . . , and 31-P are used as reference numerals indicating the fast memory 31 when it is necessary to specify one of a plurality of fast memories, but a reference numeral 31 is used when indicating an arbitrary fast memory. In addition, in the present embodiment, reference numerals 32-1, . . . , and 32-Q are used as reference numerals indicating the slow memory 32 when it is necessary to specify one of a plurality of slow memories, but a reference numeral 32 is used when indicating an arbitrary slow memory.

The memory access controller 70 is connected to a fast core 21-1, . . . , a fast core 21-M, a fast memory 31-1, . . . , a fast memory 31-P, a slow core 22-1, . . . , a slow core 22-N, and a slow memory 32-1, . . . , a slow memory 32-Q through an internal bus 60.

The management processor 10 is connected to the fast core 21-1, . . . , the fast core 21-M, the fast memory 31-1, . . . , the fast memory 31-P, the slow core 22-1, . . . , the slow core 22-N, the slow memory 32-1, . . . , the slow memory 32-Q, the memory access controller 70, the external memory 40, and the DMAC 50 through the internal bus 60.

The fast core 21 is connected to the management processor 10 and the memory access controller 70 through the internal bus 60.

The slow core 22 is connected to the management processor 10 and the memory access controller 70 through the internal bus 60.

The fast memory 31 is connected to the management processor 10, the memory access controller 70, the external memory 40, and the DMAC 50 through the internal bus 60.

The slow memory 32 is connected to the management processor 10, the memory access controller 70, the external memory 40, and the DMAC 50 through the internal bus 60.

In the information processing system 1 according to the present embodiment, the elements may be connected to each other through a network instead of the internal bus 60. In addition, the memory access controller 70 is connected to the fast core 21-1, . . . , the fast core 21-M, the fast memory 31-1, . . . , the fast memory 31-P, the slow core 22-1, . . . , the slow core 22-N, and the slow memory 32-1, . . . , the slow memory 32-Q through an internal bus 60, but is not limited to the connecting method.

The fast core 21 and the slow core 22 access the fast memory 31 and the slow memory 32, respectively, through the memory access controller 70, differently from a case of the information processing system 1 according to the first embodiment.

The memory access controller 70 correlates a logical address designated by the fast core 21 with a physical address for accessing the fast memory 31. In addition, the memory access controller 70 correlates a logical address designated by the slow core 22 with a physical address for accessing the slow memory 32.

The fast cores 21-1, . . . , and 21-M may respectively have an independent logical address space, and the logical address space may be shared by some fast cores 21 of the fast cores 21-1, . . . , and 21-M. In the same manner, the slow cores 22-1, . . . , and 22-N may respectively have an independent logical address space, and the logical address space may be shared by some slow cores 22 of the slow cores 22-1, . . . , and 22-N. In addition, some of the fast cores 21-1, . . . , and 21-M and the slow cores 22-1, . . . , and 22-N may share the logical address space.

A configuration of a memory space may be properly modified according to a specification of the information processing system 1. For example, a single memory space may be configured by the single fast memory 31, and may be configured by the plurality of fast memories 31. If the memory space is shared by the fast core 21 and the slow core 22, it is preferable that the memory space is configured by the fast memory 31 and the slow memory 32.

The management processor 10 can communicate with the memory access controller 70, and the management processor 10 can request the memory access controller 70 to correlate a logical address area with a memory area. That is, for example, if an issued task requires high responsiveness, the management processor 10 requests that a memory area which is assigned for the task is configured by the fast memory 31. In addition, for example, if the issued task does not require the high responsiveness, the management processor 10 requests that a memory area which is assigned for the task is configured by the slow memory 32.

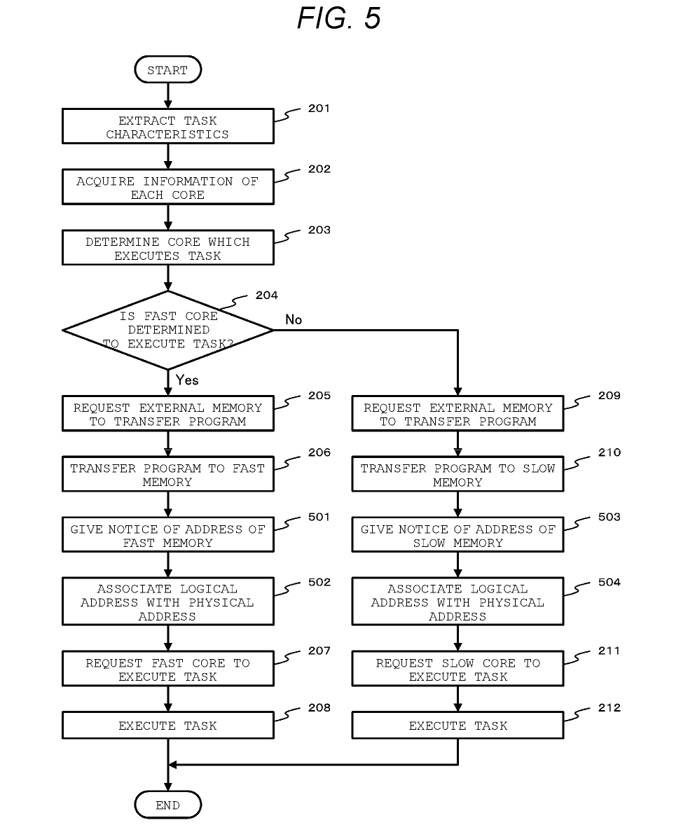

FIG. 5 is a flowchart of task execution processing carried out by the information processing system 1 according to the second embodiment. The flowchart illustrates processing from issuing of the task to executing of the task.

In the information processing system 1 according to the second embodiment, the DMAC 50 reads a program or data requested by the management processor 10 from the external memory 40, transfers the read program or data to the fast memory 31 requested by the management processor 10 (step 206). Thereafter, the management processor 10 notifies the memory access controller 70 of a physical address of a transfer destination area and a logical address corresponding to the physical address, of the fast memory 31 to which the read program or data is transferred (step 501), differently from the information processing system according to the first embodiment. Thereby, the memory access controller 70 can obtain a logical address and a physical address, and can correlate the logical address with the physical address. Thereby, the fast core 21 can access the fast memory 31 through the memory access controller 70.

In addition, in the information processing system according to the second embodiment, subsequently to step 501, the memory access controller 70 correlate the logical address and the physical address which are accessed by the fast core 21 (step 502). The memory access controller 70 stores the correlation between the logical address and the physical address which are accessed by the fast core 21 in the memory access controller 70 in, for example, a table form. The management processor 10 may correlate a physical address and a logical address of an area to which a program or data is transferred when the system starts, rather than whenever time the execution is requested. If the management processor 10 correlate the physical address and the logical address when the system starts, the fast core 21 accesses the logical address which was previously correlated, when the fast core 21 accesses the fast memory 31. In the information processing system according to the second embodiment, subsequently to step 502, the management processor 10 requests the fast core 21 to execute the task (step 207). Then, the fast core 21 that is requested to execute the task reads a predetermined program from the fast memory 31 and executes the task by interpreting description of the program (step 208).

In the same manner, in the information processing system according to the second embodiment, the DMAC 50 reads a program or data requested by the management processor 10 from the external memory 40, transfers the read program or data to the slow memory 32 requested by the management processor 10 (step 210), and thereafter, the management processor 10 notifies the memory access controller 70 of an address of a transfer destination area of the slow memory 32 to which the read program or data is transferred (step 503), differently from the information processing system 1 according to the first embodiment. Thereby, the memory access controller 70 can obtain the logical address and the physical address, and can correlate the logical address with the physical address. Thereby, the slow core 22 can access the slow memory 32 through the memory access controller 70.

In addition, in the information processing system 1 according to the second embodiment, subsequently to step 503, the memory access controller 70 correlates the logical address and the physical address which are accessed by the slow core (step 504). The memory access controller 70 stores the correlation between the logical address and the physical address which are accessed by the slow core 22 in the memory access controller 70 in, for example, a table form. The management processor 10 may correlate a physical address and a logical address of an area to which a program or data is transferred when the system starts, rather than whenever the execution of the task is requested. If the management processor 10 correlates the physical address and the logical address when the system starts, the slow core 22 accesses the logical address which was previously correlated, when the slow core 22 accesses the slow memory 32. In the information processing system 1 according to the second embodiment, subsequently to step 504, the management processor 10 requests the slow core 22 to execute the task (step 211), the slow core 22 that is requested to execute the task reads a predetermined program from the slow memory 32, and executes the task by interpreting description of the program (step 212).

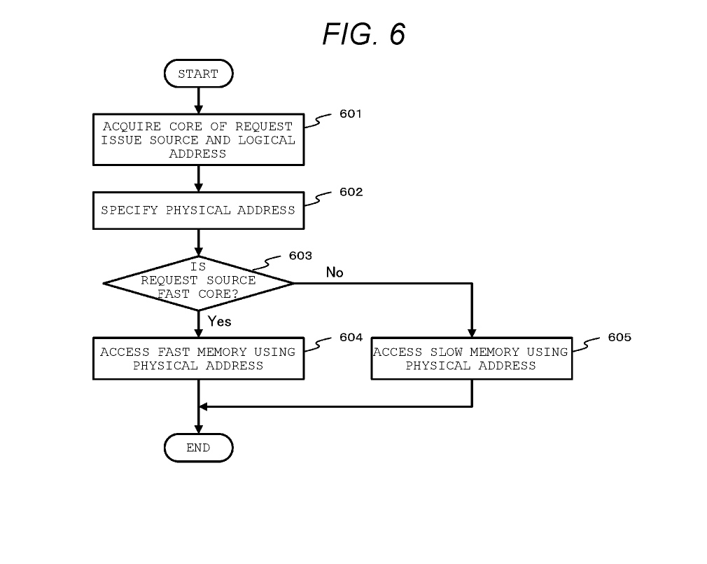

FIG. 6 is a flowchart illustrating an operation carried out by the memory access controller of the information processing system 1 according to the second embodiment. The flowchart illustrates processing from when the memory access controller 70 receives data request from one core of the fast core 21 and the slow core 22 to when the memory access controller 70 accesses a memory.

If the memory access controller 70 receives the data request from one core of the fast core 21 and the slow core 22, the memory access controller 70 acquires a logical address corresponding to a core of a data request issuer and the data request (step 601).

The memory access controller 70 specifies a physical address corresponding to the acquired logical address by using, for example, a table in the memory access controller 70 (step 602).

The memory access controller 70 determines whether the core of a data request source is the fast core 21 or the slow core 22 (step 603).

If the core of the data request source is the fast core 21 (Yes in step 603), the memory access controller 70 accesses the fast memory 31 by using the physical address which is specified in step 602 (step 604).

If the core of the data request source is the slow core 22 (No in step 603), the memory access controller 70 accesses the slow memory 32 by using the physical address which is specified in step 602 (step 605).

According to the second embodiment, a core is used properly according to the task of target to be executed, and a memory that the core uses is used properly according to performance of the core which performs processing, in the information processing system 1, in the same manner as in the first embodiment. Accordingly, use efficiency of the core can increase, and power consumption of the information processing system 1 can be reduced. In addition, according to the second embodiment, it is possible to increase flexibility of a connection relationship between the fast core 21 and the fast memory 31, and flexibility of a connection relationship between the slow core 22 and the slow memory 32, in the information processing system 1.

### Third Embodiment

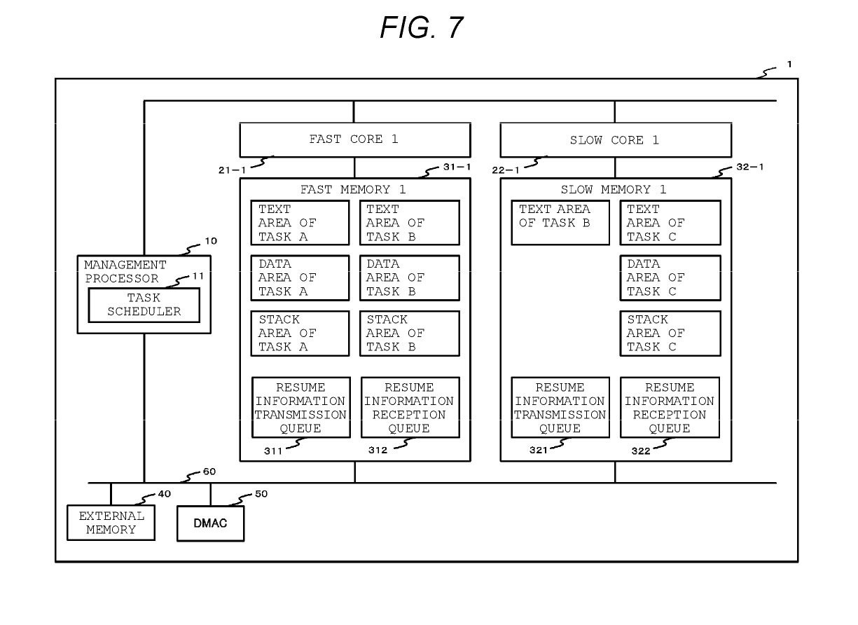

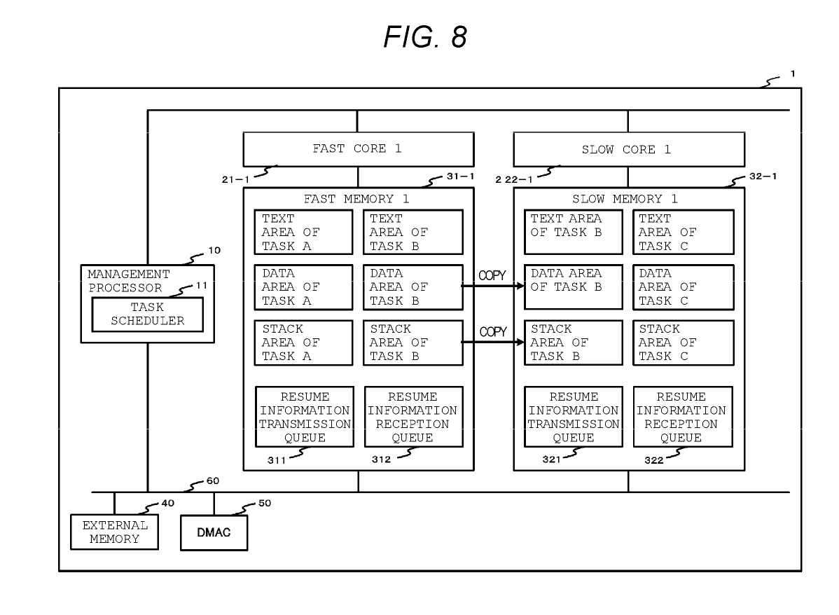

FIG. 7 and FIG. 8 are conceptual diagrams illustrating an operation carried out by an information processing system 1 according to a third embodiment, when a core which performs a task B is changed from the fast core 21 to the slow core 22. In the third embodiment, the same symbols or reference numerals will be attached to configurations having the same function as or a similar function to the first embodiment, and description thereof will be omitted. In addition, other configurations which are not described in the following configuration are the same as those in the first embodiment.

FIG. 7 illustrates a configuration of the information processing system 1 in a case where there are one fast core 21, one fast memory 31, one slow core 22, and one slow memory 32, that is, a case where a task A and a task B are executed by the fast core 21-1 and a task C is executed by the slow core 22-1, in the information processing system 1 including the management processor 10, the fast core 21-1, the fast memory 31-1, the slow core 22-1, the slow memory 32-1, the external memory 40, and the DMAC 50. The information processing system 1 according to the present embodiment is not limited to a case where there are one fast core 21 and one slow core 22.

A text area, a data area, and a stack area which correspond to the task A, and a text area, a data area, and a stack area which correspond to the task B, respectively, are assigned to the fast memory 31-1 by the task scheduler 11. A text area, a data area, and a stack area which correspond to the task C are assigned to the slow memory 32-1 by the task scheduler 11.

Here, the text area is an area to which program content of the task is copied, and has fixed content for each task. The data area includes a static area and a heap area. The static area stores a static variable such as a global variable. The heap area is an area to which, for example, processing of the task can be dynamically assigned, or released. The stack area stores, for example, a local variable of processing of the task, or a register.

The text area corresponding to the task B has a fixed content, and thus, can be shared by the fast memory 31-1 and the slow memory 32-1, when the information processing system 1 starts or while the information processing system 1 operates. Accordingly, the task scheduler 11 transfers the text area corresponding to the task B of the fast memory 31-1 to the slow memory 32-1, when the information processing system 1 starts or while the information processing system 1 operates.

In addition, areas for a resume information transmission queue 311 and 321 and a resume information reception queue 312 and 322 are respectively assigned to the fast memory 31-1 and the slow memory 32-1. The resume information transmission queues 311 and 321 and the resume information reception queues 312 and 322 are used when resume information is transmitted and received to and from the core. The resume information includes information on an element in which processing will be resumed, such as a program counter.

FIG. 8 schematically illustrates copying of data as the management processor 10 transfers data of the data area and the stack area which correspond to the task B stored in the fast memory 31-1 to the slow memory 32-1, if the management processor 10 determines to switch the core which executes the task B from the fast core 21-1 to the slow core 22-1, in a state where the task A and the task B are executed by the fast core 21-1 and the task C is executed by the slow core 22-1 as illustrated in FIG. 7.

As illustrated in FIG. 8, when the core which executes the task B is switched from the fast core 21-1 to the slow core 22-1, the data of the data area and the stack area which correspond to the task B stored in the fast memory 31-1 becomes a target to be transferred to the slow memory 32-1. Since the text area corresponding to the task B is fixed content, timing when the text area is transferred to the slow memory 32-1 does not need to be equal to timing when the core which executes the task B is switched from the fast core 21-1 to the slow core 22-1.

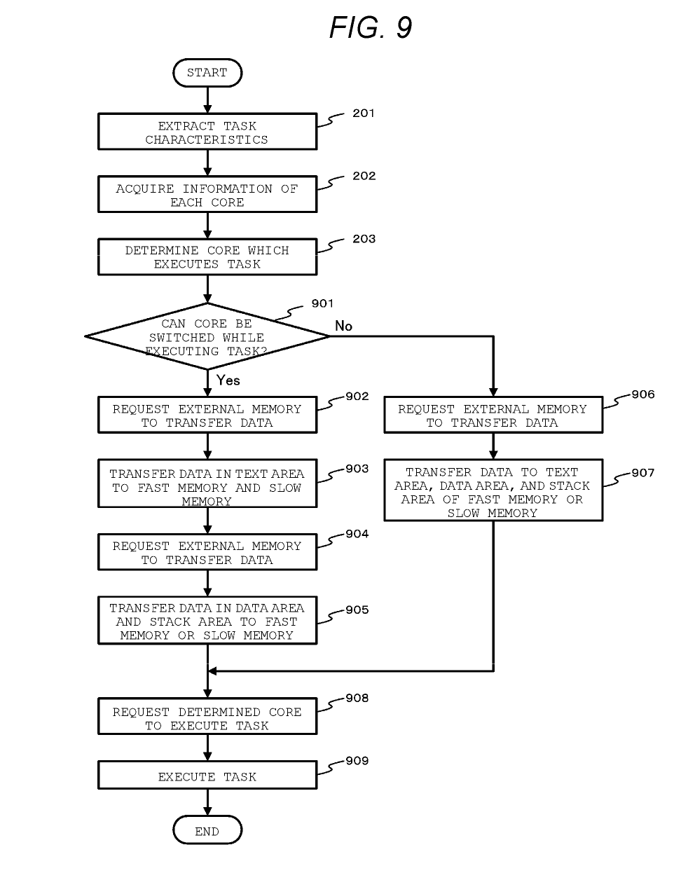

FIG. 9 is a flowchart of task execution processing carried out by the information processing system 1 according to the third embodiment. The flowchart illustrates processing from when the task is issued to when execution of the task starts.

In the information processing system 1 according to the third embodiment, the management processor 10 acquires information on resource usage of each of the fast core 21-1, . . . , the fast core 21-M and the slow core 22-1, . . . , the slow core 22-N (step 202), differently from the information processing system 1 according to the first embodiment. In addition, the management processor 10 selects and determines a core which executes the task among the fast core 21-1, . . . , the fast core 21-M and the slow core 22-1, . . . , the slow core 22-N, based on the information (step 203). Thereafter, the management processor 10 determines whether or not a core of an execution source is switched during an operation of the task (step 901). The determination is made by, for example, characteristics of the task such as switching of foreground execution and background execution according to a change of responsiveness which is requested, or a change of a use efficiency rate of the core of the execution source according to execution of the task, the amount of calculation which is generated, and the amount of data to be accessed.

If it is determined that the core of the execution source is switched during the operation of the task (Yes in step 901), the management processor 10 requests the DMAC 50 to transfer a text area of the task stored in the external memory 40 to the fast memory 31 and the slow memory 32 (step 902). After receiving request from the management processor 10, the DMAC 50 transfers the text area of the task from the external memory 40 to both the fast memory 31 and the slow memory 32 (step 903).

Furthermore, the management processor 10 requests the DMAC 50 to transfer a data area and a stack area of the task stored in the external memory 40 to any one of the fast memory 31 and the slow memory 32 (step 904). After receiving the request from the management processor 10, the DMAC 50 transfer the data area and the stack area of the task from the external memory 40 to one of the fast memory 31 and the slow memory 32 (step 905).

When the core which executes the task is switched, the data area and the stack area which correspond to a core of a switching destination are overwritten by the data area and the stack area which correspond to a core of a switching source. For that reason, although the data area and the stack area of the task are transferred to both the fast memory 31 and the slow memory 32 at a point in time when execution of the task starts, there is little influence in an operation of the information processing system 1. For that reason, in step 904, the management processor 10 may request the DMAC 50 to transfer the data area and the stack area of the task stored in the external memory 40 to both the fast memory 31 and the slow memory 32. In this case, in step 905, after receiving the request from the management processor 10, the DMAC 50 transfers the data area and stack area of the task to both the fast memory 31 and the slow memory 32 from the external memory 40.

If the management processor 10 determines that the core of the execution source is not switched during the operation of the task due to reason in which the amount of resources that are used from when the task starts to when the task ends does not change (No in step 901), the management processor 10 requests the DMAC 50 to transfer the text area, the data area, and the stack area of the task stored in the external memory 40 to the fast memory 31 or the slow memory 32 (step 906). After receiving the request from the management processor 10, the DMAC 50 transfers the text area, the data area, and the stack area of the task from the external memory 40 to the fast memory 31 or the slow memory 32 (step 907).

After the text area, the data area, and the stack area of the task is transferred from the external memory 40 to the fast memory 31 or the slow memory 32, the management processor 10 transfers an execution request to the core which is selected and determined in step 203 (step 908). Thereby, the core which receives the execution request reads predetermined data from a corresponding memory, and starts execution of the task (step 909).

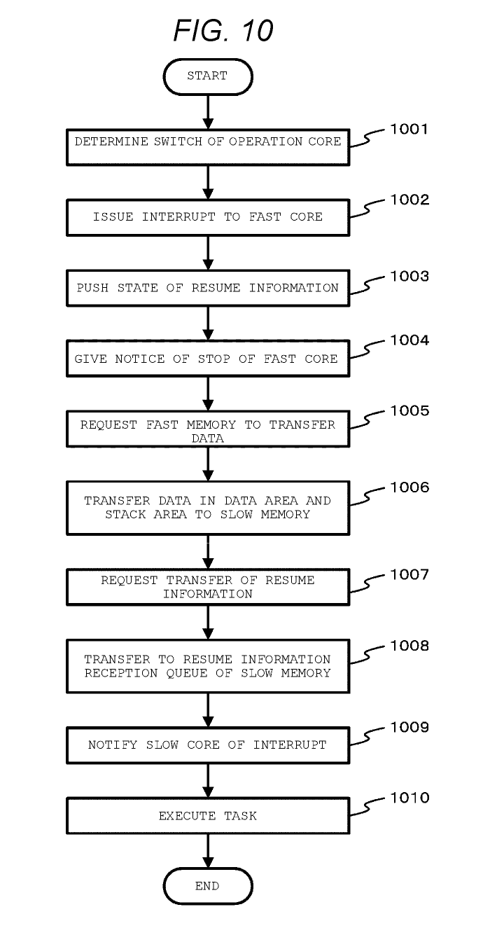

FIG. 10 illustrates a flowchart of processing when an operation core that executes a task, of the information processing system 1 according to the third embodiment is switched from the fast core 21 to the slow core 22, and a flowchart of processing when the task executed by the fast core 21 is moved to the slow core 22.

The management processor 10 determines that the operation core which executes the task is switched from the slow core 22 to the fast core 21 (step 1001). Factors to determine moving of the operation core include a case where an operation of the task moves from a foreground to a background, a case where the task is suspended, and a case where a certain task causes shortage of memory capacity and decreases operation speeds of other tasks, and the like.

Thereafter, the management processor 10 stops a task operation for the fast core 21, and issues to the fast core 21 interrupt for executing the task, which is running on the fast core 21, using the slow core 22 (step 1002).

After being notified of the interrupt, the task operation of the fast core 21 stops, and the fast core 21 pushes a state of resume information to a resume information transmission queue 311 of the fast memory 31 (step 1003). In addition, when the task operation of the fast core 21 stops, a register of the fast core 21 is retreated, and thus, the fast core 21 stores various types of operation information of the fast core 21 in the stack area. The resume information transmission queue 311 is a queue which is used by the fast core 21 for managing resume information.

The fast core 21 notifies the management processor 10 that the fast core 21 stops an operation, by issuing interrupt (step 1004).

After the interrupt is notified, the management processor 10 requests the DMAC 50 to transfer a data area and a stack area of the task stored in the fast memory 31 to the slow memory 32 (step 1005). After receiving the request from the management processor 10, the DMAC 50 transfers the data area and the stack area of the task from the fast memory 31 to the slow memory 32 (step 1006).

The management processor 10 requests the DMAC 50 to transfer resume information from the fast memory 31 to the slow memory 32 (step 1007). After receiving the request from the management processor 10, the DMAC 50 reads the resume information from the resume information transmission queue 311 of the fast memory 31, and transfers the read resume information to a resume information reception queue 322 of the slow memory 32 (step 1008).

After the DMAC 50 completes the transfer of the data area and the stack area of the task to the slow memory 32, and the transfer of the resume information to the resume information reception queue 322 of the slow memory 32, the management processor 10 notifies the slow core 22 of interrupt for requesting execution of the task (step 1009).

After receiving the interrupt, the slow core 22 reads the resume information from the resume information reception queue 322, recovers a stopped state of the fast core 21 from the stack area, and executes the task (step 1010).

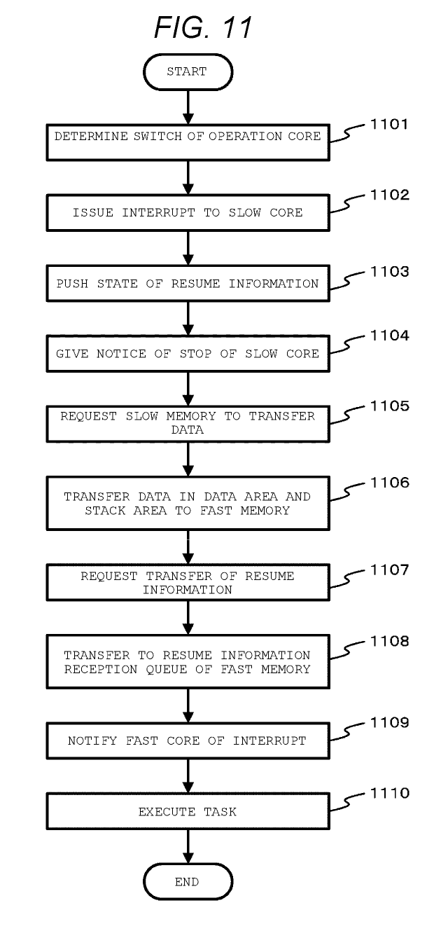

FIG. 11 is a flowchart of processing when the operation core that executes the task, of the information processing system 1 according to the third embodiment is switched from the slow core 22 to the fast core 21. That is, FIG. 11 illustrates a flowchart of processing when the task executed by the slow core 22 is moved to the fast core 21.

The management processor 10 determines that the operation core that executes the task is switched from the slow core 22 to the fast core 21 (step 1101). Factors to determine switching of the operation core include a case where an operation of the task moves from a background to a foreground, a case where executing of a certain task causes shortage of memory capacity and decreases operation speeds of other tasks, a case where there is a margin in a resource of the fast core 21, and the like.

Thereafter, the management processor 10 stops an operation for the slow core 22, and issues to the slow core 22 interrupt for executing the task, which is running on the slow core 22, using the fast core 21 (step 1102).

After being notified of the interrupt, the task operation of the slow core 22 stops, and the slow core 22 pushes a state of resume information to a resume information transmission queue 321 of the slow memory 32 (step 1103). In addition, when the task operation of the slow core 22 stops, a register of the slow core 22 is retreated, and thus, the slow core 22 stores various types of operation information of the slow core 22 in the stack area. The resume information transmission queue 321 is a queue which is used by the slow core 22 for managing resume information.

The slow core 22 notifies the management processor 10 that the slow core 22 stops an operation, by issuing interrupt (step 1104).

After the interrupt is notified, the management processor 10 requests the DMAC 50 to transfer a data area and a stack area of the task stored in the slow memory 32 to the fast memory 31 (step 1105). After receiving the request from the management processor 10, the DMAC 50 transfers the data area and the stack area of the task from the slow memory 32 to the fast memory 31 (step 1106).

The management processor 10 requests the DMAC 50 to transfer resume information from the slow memory 32 to the fast memory 31 (step 1107). After receiving the request from the management processor 10, the DMAC 50 reads the resume information from the resume information transmission queue 321 of the slow memory 32, and transfers the read resume information to a resume information reception queue 312 of the fast memory 31 (step 1108).

After the DMAC 50 completes the transfer of the data area and the stack area of the task to the fast memory 31, and the transfer of the resume information to the resume information reception queue 312 of the fast memory 31, the management processor 10 notifies the fast core 21 of interrupt for requesting execution of the task (step 1109).

After receiving the interrupt, the fast core 21 reads the resume information from the resume information reception queue 312, and executes the task (step 1110).

According to the third embodiment, a core is used properly according to the task of target to be executed, and a memory that the core uses is used properly according to performance of the core which performs processing, in the information processing system 1, in the same manner as in the first embodiment. Accordingly, use efficiency of the core increases, and power consumption of the information processing system 1 is reduced. In addition, when an operating core is switched, only minimum data is disposed in both a core of a switching source and a core of a switching destination, and a core which operates according to an execution situation of the task is switched. Thereby, it is possible to prevent use efficiency of the core from decreasing, and to reduce power consumption while an execution speed which is required by the task is maintained.

Exemplary embodiments are not limited to the aforementioned embodiments, and various modifications can be made within a range not departing from the spirit of exemplary embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising:
a first core;
a second core having a processing speed that is slower than the first core;
a first memory;
a second memory having a slower response time than the first memory; and
a management processor configured to
determine a core for executing a task,
cause program data for executing the task to be copied to the first memory and then cause the first core to execute the task using the program data in the first memory, when the first core is determined as the core for executing the task, and
cause the program data for executing the task to be copied to the second memory and then cause the second core to execute the task using the program data in the second memory, when the second core is determined as the core for executing the task.

2. The information processing system according to claim 1, wherein
the management processor determines the core for executing the task based on metadata of the task.

3. The information processing system according to claim 1, wherein
the management processor determines the core for executing the task based on use states of at least one of the first core, the second core, the first memory, and the second memory.

4. The information processing system according to claim 1, wherein
the management processor determines the first core as the core for executing the task when the task is determined to be executed by foreground processing, and the second core as the core for executing the task when the task is determined to be executed by background processing.

5. The information processing system according to claim 1, wherein
the first memory is one of DRAM, SRAM, and M-Type MRAM.

6. The information processing system according to claim 1, wherein
the first core is accessible to the first memory, and not accessible to the second memory, and
the second core is accessible to the second memory, and not accessible to the first memory.

7. The information processing system according to claim 1, further comprising:
a third core having the same processing speed as the first core; and
a third memory having the same response time as the first memory, wherein
the first core is accessible to the first memory, and not accessible to the third memory, and
the third core is accessible to the third memory, and not accessible to the first memory.

8. The information processing system according to claim 1, further comprising:
a memory access controller configured to carry out association of a logical address used by the first core with a physical address of the first memory and association of a logical address used by the second core with a physical address of the second memory, with respect to the program data for executing the task.

9. The information processing system according to claim 8, wherein
the management processor is further configured to send a notification to the memory access controller upon completion of the copy of the data, and
the memory access controller carries out the association in response to the notification.

10. The information processing system according to claim 1, wherein
the program data for executing the task include a first data portion copied to a text region of a memory, a second data portion copied to a data region of the memory, and a third data portion copied to a stack region of the memory, and
the management processor is further configured to
determine whether switch of the core for executing the task can happen during execution of the task,
cause the first, second, and third data portions to be copied to the first memory, and the first data portion to be copied to the second memory, when the first core is determined to execute the task and it is determined that the switch can happen, and
cause the second and third data portions to be copied to the second memory, when the switch of the core from the first core to the second core is determined to be carried out.

11. A method of operating an information processing system including a first core, a second core having a processing speed that is slower than the first core, a first memory, and a second memory having a slower response time than the first memory, the method comprising:
determining a core for executing a task;
copying program data for executing the task to the first memory and then causing the first core to execute the task using the program data in the first memory, when the first core is determined as the core for executing the task; and
copying the program data for executing the task to the second memory and then causing the second core to execute the task using the program data in the second memory, when the second core is determined as the core for executing the task.

12. The method according to claim 11, wherein
the core for executing the task is determined based on metadata of the task.

13. The method according to claim 11, wherein
the core for executing the task is determined based on use states of at least one of the first core, the second core, the first memory, and the second memory.

14. The method according to claim 11, wherein
the first core is determined as the core for executing the task when the task is executed by foreground processing, and the second core is determined as the core for executing the task when the task is executed by background processing.

15. The method according to claim 11, wherein
the first memory is one of DRAM, SRAM, and M-Type MRAM.

16. The method according to claim 11, wherein
when the first core is determined as the core for executing the task, no program data for executing the task are copied to the second memory, and
when the second core is determined as the core for executing the task, no program data for executing the task are copied to the first memory.

17. The method according to claim 11, wherein
the information processing system further includes one or more third cores having the same processing speed as the first core, and one or more third memories having the same response time as the first memory,
when the first core is determined as the core for executing the task, no program data for executing the task are copied to any of the one or more third memories.

18. The method according to claim 11, wherein
carrying out an association of a logical address used by the first core with a physical address of the first memory and an association of a logical address used by the second core with a physical address of the second memory, with respect to the program data for executing the task.

19. The method according to claim 11, wherein
the program data for executing the task include a first data portion copied to a text region of a memory, a second data portion copied to a data region of the memory, and a third data portion copied to a stack region of the memory, and the method further comprises
determining whether switch of the core for executing the task can happen during execution of the task;
copying the first, second, and third data portions to the first memory, and the first data portion to the second memory, when the first core is determined to execute the task and it is determined that the switch can happen; and
copying the second and third data portions to the second memory, when the switch of the core from the first core to the second core is determined to be carried out.
